(19) United States
(12) Patent Application Publication
(10) Pub. No.: US 2017/0341568 A1
(43) Pub. Date: Nov. 30, 2017

(54) SYSTEM PROVIDING LIGHTING TO VEHICLE WHEEL SPINNERS AND COVERS

(71) Applicant: Mark C. Englert, Stockbridge, GA (US)

(72) Inventor: Mark C. Englert, Stockbridge, GA (US)

(21) Appl. No.: 15/344,158

(22) Filed: Nov. 4, 2016

Related U.S. Application Data
(60) Provisional application No. 62/342,102, filed on May 26, 2016.

(51) Int. Cl. B60Q 1/32; B60R 16/027; B60B 7/20; B60B 7/04; B60Q 1/00; B60R 16/033; B60Q 1/26

(52) U.S. Cl. CPC B60Q 1/326; B60R 16/033; B60R 16/027; B60Q 1/2696; B60B 7/04; B60Q 1/0076; B60B 7/20; B60B 2900/571; B60B 2900/572

(57) ABSTRACT

Light Emitting Diode (LED) illumination is provided to various aspects of vehicle wheels, including wheel covers and wheel spinners. Unlike after-market add-on illumination, the wheel covers and wheel spinners described herein are built into and integrated with the wheel covers and wheel spinners, providing safe and effective illumination for the user. The wheel covers and wheel spinners can include a centrally located power supply and a switch. An optional cover may be disposed over the LEDs. With the LEDs formed into the wheel, the optional covers may be flush with and shaped in a shape to match the wheel. The wheels may be wheels from cars, trucks, trailers, recreational vehicles, all-terrain vehicles, motorcycles, golf carts and the like.

### CROSS-REFERENCE TO RELATED APPLICATIONS

This application claims the benefit of priority to U.S. provisional patent application No. 62/342,102, filed May 26, 2016, the contents of which are herein incorporated by reference.

### BACKGROUND OF THE INVENTION

### 1. Field of the Invention

One or more embodiments of the invention relates generally to illuminated wheel covers and wheel spinners. More particularly, the invention relates to wheel covers and wheel spinners having embedded light emitting diode (LED) lights disposed therein for use in cars, trucks, recreational vehicles, all-terrain vehicles (ATVs), motorcycles, golf carts, and the like.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

With the increasing popularity of LEDs, various uses have been proposed to use this lighting product. On vehicles, LED systems has been used, for example, to providing lighting effects under a vehicle, where the LED system is directed to shine a light down from the underside of the vehicle, onto a road surface.

More recently, adding lighting effects to other parts of the vehicle has been performed. This lighting has been applied to vehicles as a post-production, add-on modification. In some embodiments, LED systems have been attached to wheels, around headlights, around taillights, under the vehicle, and the like.

These add-on systems, however, suffer from several issues. For example, often, a user must make modifications to their vehicle to add on such lighting systems. These modifications may include drilling holes, using attachment devices, such as glues or screws, running electrical wires, and the like. These modifications could void warranties and could provide installation difficulties. Moreover, when lighting systems are added to moving components, such as spinning wheels, wheel covers, wheel spinners, or the like, there is a safety issue should the attachment means not be strong enough or eventually fail due to heat, moisture, rotational forces, or the like.

In view of the foregoing, it is clear that these traditional techniques are not perfect and leave room for more optimal approaches to provide lighting effects on wheels, rims, spinning rims and wheel covers for vehicles.

### SUMMARY OF THE INVENTION

Embodiments of the present invention provide a wheel spinner operable to be rotatably mounted on a wheel comprising one or more integrated LEDs disposed within the wheel spinner; a battery pack disposed in a central region of the wheel spinner; a switch disposed in the central region of the wheel spinner; and wiring interconnecting the LEDs with the battery pack.

Embodiments of the present invention further provide a wheel cover operable to be fixed on a wheel comprising one or more integrated LEDs disposed within the wheel cover; a battery pack disposed in a central region of the wheel cover; a switch disposed in the central region of the wheel cover; and wiring interconnecting the LEDs with the battery pack.

In some embodiments, the switch is one of a motion switch, a photo switch and a remote switch. In some embodiments, the wiring is disposed within the wheel cover or spinner.

In some embodiments, the wheel cover or wheel spinner includes a cover disposed over one or more of the one or more integrated LEDs.

In some embodiments, the LEDs are disposed on one or both sides of the wheel cover or wheel spinner. In some embodiments, the LEDs are disposed in a cutout formed in the wheel cover or wheel spinner, and the LEDs include a single LED or multiple LEDs in an LED illumination bar.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is an exploded perspective view of a wheel spinner having LED illumination according to an exemplary embodiment of the present invention;

FIG. 2 is an exploded perspective view of an alternate embodiment of a wheel spinner having LED illumination;

FIG. 3 is a partially cut-away exploded perspective view of the wheel spinner having LED illumination of FIG. 2;

FIG. 4 is a partially cut-away exploded perspective view of a wheel spinner having LED illumination according to another exemplary embodiment of the present invention;

FIG. 5 is a side view of a wheel cover having LED illumination according to an exemplary embodiment of the present invention;

FIG. 6 is an exploded perspective view of the wheel cover having LED illumination of FIG. 5; and

FIG. 7 is an exploded side view of the wheel cover having LED illumination of FIG. 5.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

A description of an embodiment with several components in communication with each other does not imply that all such components are required. On the contrary a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide LED illumination to various aspects of vehicle wheels, including wheel covers and wheel spinners. Unlike after-market add-on illumination, the wheel covers and wheel spinners described herein are built into and integrated with the wheel covers and wheel spinners, providing safe and effective illumination for the user. The wheel covers and wheel spinners can include a centrally located power supply and a switch. An optional cover may be disposed over the LEDs. With the LEDs formed into the wheel, the optional covers may be flush with and shaped in a shape to match the wheel. The wheels may be wheels from cars, trucks, trailers, recreational vehicles, all-terrain vehicles, motorcycles and the like.

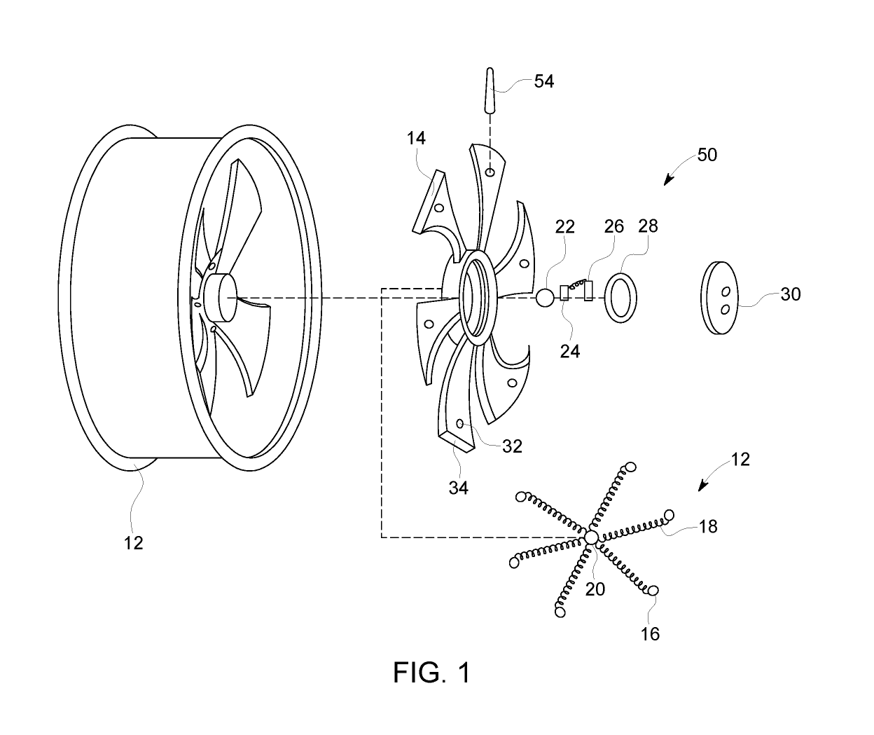

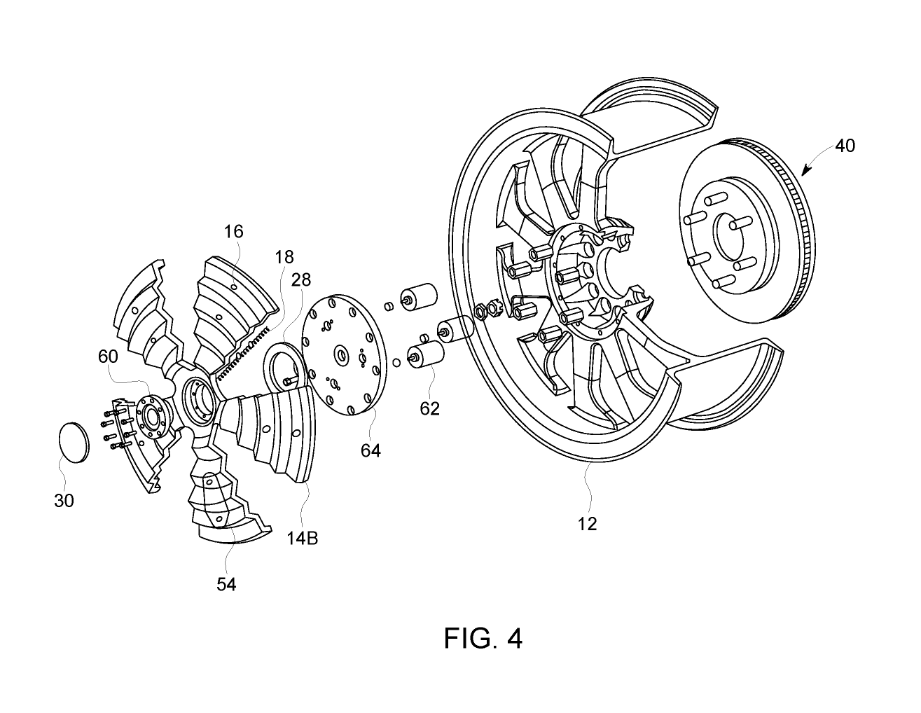

FIGS. 1 through 4 illustrate a wheel 12 for a vehicle that has a wheel spinner 14, 14A having a plurality of lights, such as LEDs 16, disposed therein. The LEDs 16 can be integrated into the wheel spinner 14 and permanently attached thereto. Unlike conventional lighting, with the LEDs 16 integrated into the wheel spinner 14, 14A, there is no risk of the lighting coming off due to centrifugal force, failed adhesive, or the like. Moreover, unlike conventional, after-market add-on lighting, the integrated LED lighting of the present invention is created as an integral unit, with the wiring, switch and power supply all integrated into the wheel spinner 14, 14A as described below.

As shown in FIG. 1, an LED wheel spinner set can include wiring 18 that may extend from the LEDs 16 to a central connection 20. In some embodiments, the wiring 18 may be embedded within the wheel spinner 14. In other embodiments, the wiring 18 may run along a path and/or a channel formed on an inside portion of the wheel spinner 14.

In some embodiments, a switch 24 may be integrated below the battery cover 30. The switch 24 can be a remotely controlled switch, where the driver can choose when to power on or off the LEDs 16. In other embodiments, the switch 24 may be a motion detection switch, where motion of the wheel turns on the LEDs and they turn off automatically when the wheel stops moving. In either embodiments, a light sensor or diode may be used to keep the LEDs 16 turned off when a certain level of brightness is ambient or to automatically turn on the LEDs 16 when a predetermined level of darkness is present.

The power supply may be a photo cell to rechargeable battery pack 26. In some embodiments, a portion of the outer periphery of the wheel, such as a central hub or spokes 34 thereof, may be formed from solar panels, where the solar panels can charge the battery pack 26. Typically, the battery pack 26, LEDs 16 and solar panels are disposed uniformly about the wheel spinner 14 so that balance of the wheel spinner is not changed by the LEDs 16 and its accompanying components.

The battery pack 26 can be connected to the switch 24, and the switch 24 can connect to a connector 22, which may be used to connect power to the LEDs 16, as shown in FIG. 1. Of course, other configurations may be used within the scope of the present invention.

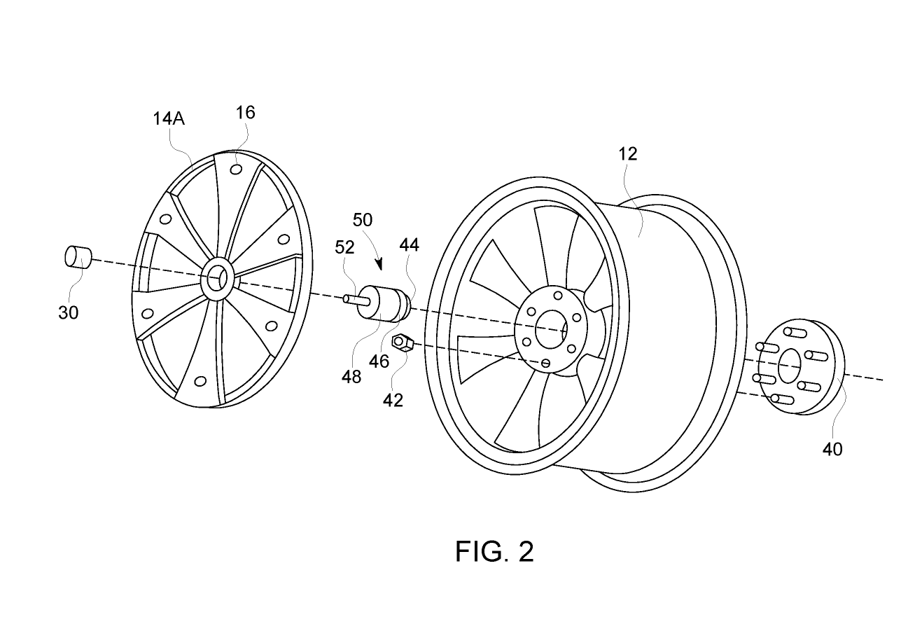

The wheel 12 may include conventional components, as shown in FIG. 2, such as the lug nuts 42 and a brake rotor 40, for example. The wheel 12 may have various widths and diameters as may be known in the art, depending on the particular vehicle with which the wheel is used.

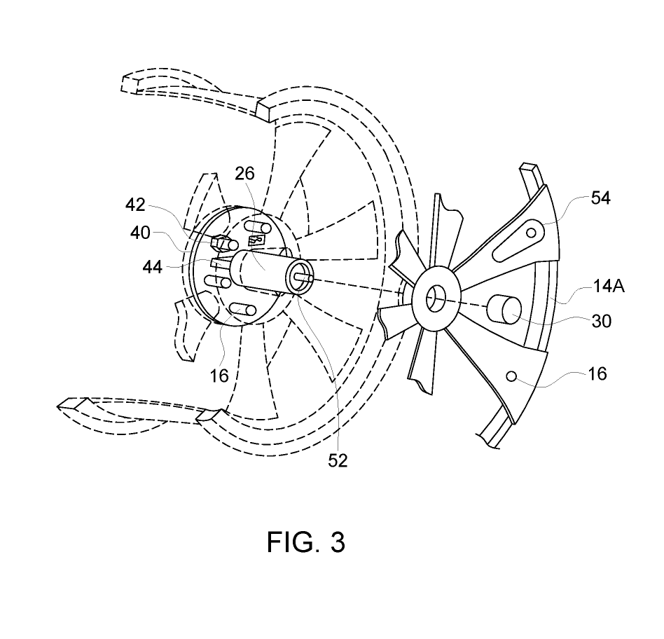

In FIGS. 1 and 3 some embodiments, a cover 54 may be disposed over the LEDs 16. The cover 54 may serve several purposes, including protecting the LEDs 16 from physical or weather related damage, diffuse the light from the LEDs 16, and provide an aesthetically pleasing appearance for the exterior of the wheel spinner 14, 14A. The cover 54 may be opaque, transparent, patterned, colored or the like. The cover 54, of course, is an optional item that may or may not be present on the wheel spinner 14, 14A.

In some embodiments, a single unit 50 may contain an integrated battery 44, remote 46 and connector 48 with a spinner lug 52 extending from the single unit 50, as shown in FIG. 2. While FIG. 1 shows the components separate and FIG. 2 shows the components integrated, various combinations are contemplated within the scope of the present invention.

When the wheel spinner 14, 14A is attached to the wheel 12, a cap may be disposed to keep the wheel spinner 14, 14A on the wheel 12. In some embodiments, the cap may be a solar cap 30 to charge the battery pack 26. A seal/bearing 28 may be used to protect the battery pack 26, remote controller 24 and other similar internal electronics.

In an alternate embodiment, a wheel spinner 14B can be designed similar to the wheel spinners 14, 14A described above, except that a mounting plate 64 may be spaced from the wheel 12 via spacers 62. An outer housing 60 may be placed over the battery and remote (not specifically shown).

Regardless of configuration, the wheel spinner 14, 14A, 14B each provide integrated LED illumination into a wheel spinner, with the associated electronics (battery pack, remote, sensors, and the like) located in a central region of the wheel spinner.

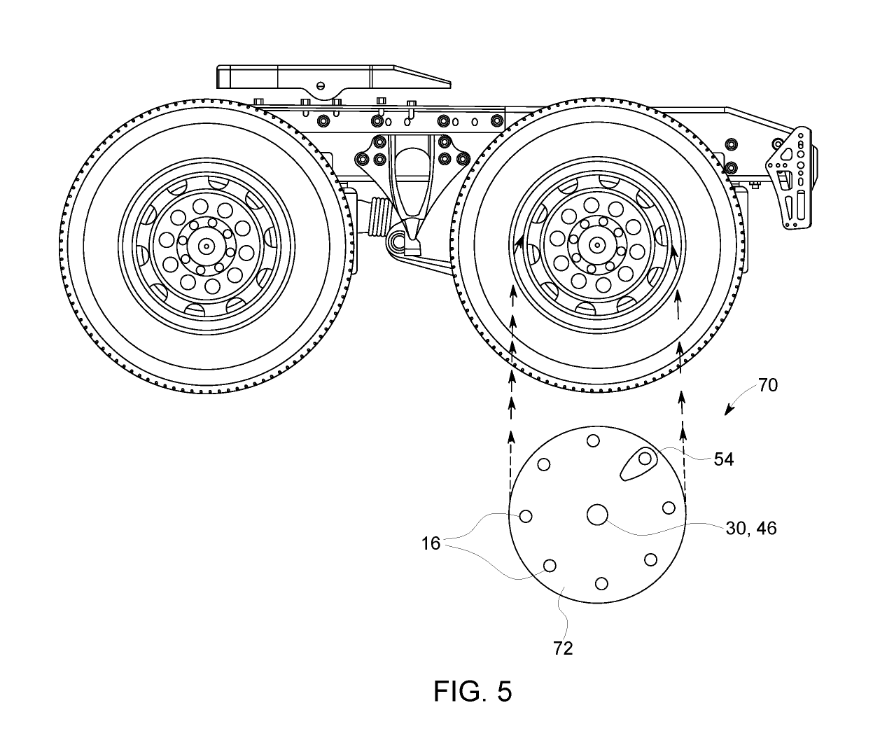

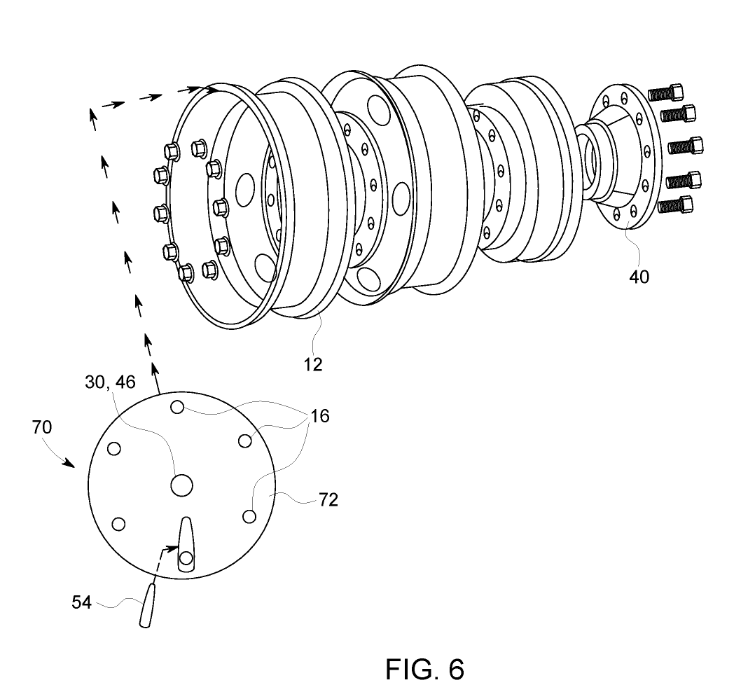

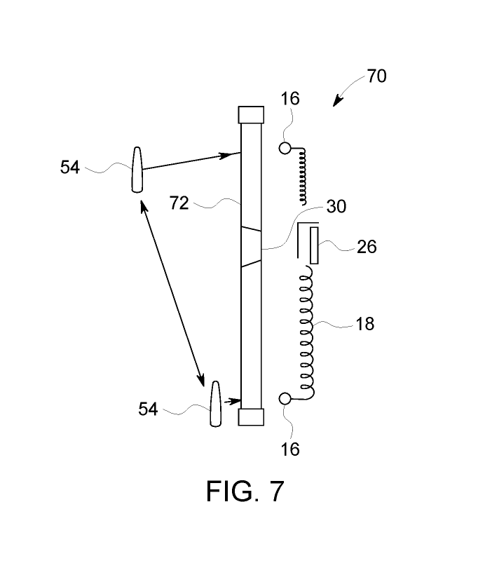

While FIGS. 1-4 show wheel spinners, referring now to FIGS. 5 through 7, a wheel cover 70 can include an outer cap 30 which may include solar cells 46 for charging a battery pack 26 located in a central region of the wheel cover 70. The battery pack 25 may connect to LEDs 16 via an electrical connection, such as a wire 18. Optional covers 54 may cover the LEDs 16 as described above with respect to the wheel spinners. The wheel cover 70 can include an exterior surface 72 where the LEDs 16 are integrated therewithin. The wheel cover 70 may mount onto a wheel 12 in various manners as may be known in the art.

While the above describes individual LEDs, multiple LEDs, such as an LED illumination bar may be used to generate light at a particular location. Furthermore, other designs may be incorporated to position light at desired locations. For example, a single LED may be used with fiber optics to create multiple illuminated locations at a location other than the LED itself. In some embodiments, fiber optics may be used to create various effects in addition to or in place of the LEDs.

The LEDs can be positioned at various locations on the base structure (the wheel cover, the wheel spinner, or the like). For example, the LEDs may be positioned to direct light outward, away from the structure. In some embodiments, the LED's may be positioned to provide light toward the vehicle. In some embodiments, the LEDs may be positioned to provide light toward an interior of the wheel. In some embodiments, the LEDs may be positioned at a uniform distance from the hub of the wheel, providing a circular looking light when the wheel is moving. In other embodiments, the LEDs may be positioned at different locations, providing different effects when the wheel is in motion. The LEDs can be disposed in various colors, as desired for effect, safety of the like. In some embodiments, the LEDs can be multi-color LEDs or an LED illumination bar where the user can select the color of the LED by various manners known in the art.

While the above describes battery charging via solar panels, in some embodiments, the batteries may be charged by other means. For example, a motion-type charging system may be used, where motion of the wheel provides a charge to the battery. In some embodiments, a small current generation rotor and stator may be disposed within the wheel, where motion of the wheel generates power and power electronics may be incorporated into the battery, for example, for receiving a charging current from the generator. Of course, other charging systems, as may be known in the art, may be used within the scope of the present invention.

In some embodiments, the battery and charger may be eliminated from the LED system and a power generator may be used to generate power to light the LEDs when the vehicle is in motion. In this embodiment, power electronics may be used to prevent an over-current condition, where a maximum current is delivered to the LEDs once a given tire rotation is reached. In this embodiment, the switch may also be eliminated, as the rotation of the wheel itself would automatically turn on the LEDs, and they would automatically turn off when wheel rotation stops.

When a power supply, such as a battery, is used, various electrical connections may be used to connect the LEDs with the power supply. Typically, each LED may be wired to the battery, often with each “spoke” of LEDs wired in parallel with each other spoke, and each LED in the spoke wired in series. Of course, other wiring schemes may be used within the scope of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A wheel spinner operable to be rotatably mounted on a wheel, comprising:
one or more integrated LEDs disposed within the wheel spinner;
a battery pack disposed in a central region of the wheel spinner;
a switch disposed in the central region of the wheel spinner; and
wiring interconnecting the LEDs with the battery pack.

2. The wheel spinner of claim 1, wherein the switch is one of a motion switch, a photo switch and a remote switch.

3. The wheel spinner of claim 1, wherein the wiring is disposed within the wheel spinner.

4. The wheel spinner of claim 1, further comprising a cover disposed over one or more of the one or more integrated LEDs.

5. The wheel spinner of claim 1, wherein the LEDs are disposed on one or both sides of the wheel spinner.

6. The wheel spinner of claim 1, wherein the LEDs are disposed in a cutout formed in the wheel spinner, and wherein the LEDs include a single LED or multiple LEDs in an LED illumination bar.

7. A wheel cover operable to be fixed on a wheel, comprising:
one or more integrated LEDs disposed within the wheel cover;
a battery pack disposed in a central region of the wheel cover;
a switch disposed in the central region of the wheel cover; and
wiring interconnecting the LEDs with the battery pack.

8. The wheel cover of claim 7, wherein the switch is one of a motion switch, a photo switch and a remote switch.

9. The wheel cover of claim 7, wherein the wiring is disposed within the wheel cover.

10. The wheel cover of claim 7, further comprising a cover disposed over one or more of the one or more integrated LEDs.

11. The wheel cover of claim 7, wherein the LEDs are disposed on one or both sides of the wheel cover.

12. The wheel cover of claim 7, wherein the LEDs are disposed in a cutout formed in the wheel cover, and wherein the LEDs include a single LED or multiple LEDs in an LED illumination bar.
